(19) United States
(12) Patent Application Publication
(10) Pub. No.: US 2007/0262143 A1
(43) Pub. Date: Nov. 15, 2007

(54) Card Reading Device Having Both Contact and Contactless Card Reading Functions

(76) Inventors: Jen-Hao Yu, Taoyuan County (TW); Richard Lin, Hsinchu City (TW)

Correspondence Address: NORTH AMERICA INTELLECTUAL PROPERTY CORPORATION, P.O. BOX 506, MERRIFIELD, VA, 22116, US

(21) Appl. No.: 11/456,862

(22) Filed: Jul. 12, 2006

(30) Foreign Application Priority Data
May 15, 2006 (TW) 095117121

(51) Int. Cl. G06K 7/00; G06K 7/06; G06K 7/08

(52) U.S. Cl. 235/440; 235/441; 235/451

(57) ABSTRACT

A card reading device having both contact and contactless card reading functions includes a communication interface for transmitting and receiving signals, an antenna for electromagnetically inducing a contactless card, a protocol processor for exchanging data with the contactless card through the antenna according to a predetermined communication protocol, a card slot for embedding a contact card, an identification module for identifying the contact card, and a microcontroller for processing data stored in the contactless card induced by the antenna through the protocol processor, and exchanging data with a backend device through the communication interface when a result of the identification module represents that the contact card conforms to a predetermined authentication.

### BACKGROUND OF THE INVENTION

1. Field of the Invention

The present invention provides a card reading device, and more particularly, a card reading device having both contact and contactless card reading functions.

2. Description of the Prior Art

In daily life, people often use a variety of digital identification (ID) cards, such as credit cards, ATM cards, entrance cards, health insurance cards, etc, which store ID data of users. When a user slides a digital ID card, a card reader must perform an authentication process through a network, so as to clarify the user's status. For example, when a user slides a credit card for buying a product, a card reader connects to a financial institution to perform an authentication process, and proceeds to the trading if the authentication process is successful, which is time-consuming and unsuitable for mobile financial uses, especially for those places hard to build network structures, such as large-scale amusement parks, scenic spots, etc.

In short, the prior art trading of a digital ID card is time-consuming and unsuitable for mobile payment. In addition, the digital ID card have contacts or magnetic bars for exchanging signals with card readers, which may be worn or torn with the result that the cards lose efficacy after long-term use. Moreover, the cards must be read in a specified direction, and failure may result if read in a wrong direction.

### SUMMARY OF THE INVENTION

It is therefore a primary objective of the claimed invention to provide a card reading device having both contact and contactless card reading functions. According to the claimed invention, a card reading device having both contact and contactless card reading functions comprises a communication interface for transmitting and receiving signals, an antenna for electromagnetically inducing a contactless card, a protocol processor for exchanging data with the contactless card through the antenna according to a predetermined communication protocol, a card slot for embedding a contact card, an identification module for identifying the contact card, and a microcontroller for processing data stored in the contactless card induced by the antenna through the protocol processor, and exchanging data with a backend device through the communication interface when a result of the identification module represents that the contact card conforms to a predetermined authentication.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a block diagram of a card reading device in accordance with a preferred embodiment of the present invention.

FIG. 2 illustrates a schematic diagram of operations of a card reading device in accordance with the present invention.

### DETAILED DESCRIPTION

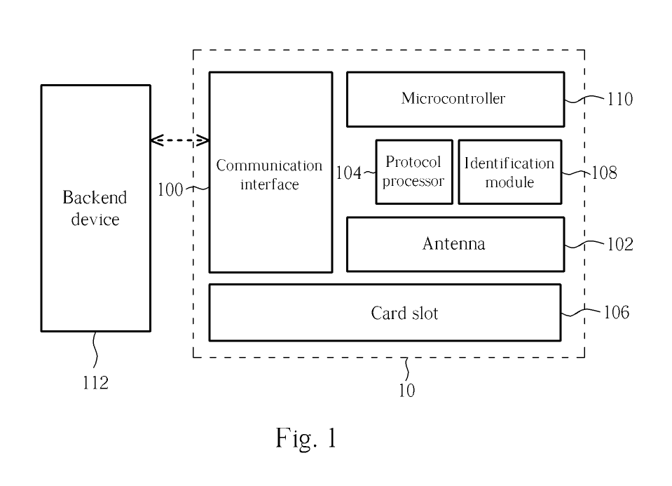

Please refer to FIG. 1, which illustrates a block diagram of a card reading device 10 in accordance with a preferred embodiment of the present invention. The card reading device 10 has both contact and contactless card reading functions, and includes a communication interface 100, an antenna 102, a protocol processor 104, a card slot 106, an identification module 108, and a microcontroller 110. The communication interface 100 is utilized for exchanging signals with a backend device 112. The antenna 102 is utilized for electromagnetically inducing a contactless card. The protocol processor 104 is utilized for exchanging data with the contactless card through the antenna 102 according to a predetermined communication protocol. The card slot 106 is utilized for embedding a contact card. The identification module 108 is utilized for identifying the contact card in the card slot 106. The microcontroller 110 is utilized for processing data stored in the contactless card induced by the antenna 102 through the protocol processor 104, and exchanging data with the backend device 112 through the communication interface 100 when a result of the identification module 108 represents that the contact card in the card slot 106 conforms to a predetermined authentication.

Therefore, the card reading device 10 can perform the contact and contactless card reading functions. When performing the contact card reading function, a user can wedge a contact card into the card slot 106. Then, the identification module 108 determines whether the contact card in the card slot 106 is authorized or not. If so, the card reading device 10 will perform corresponding operations. For example, if the contact card is an ATM card issued by a financial organization, the identification module 108 can include a secure application module issued by a financial institution (ex. a bank or credit card international organization) for performing an authentication process. Therefore, when a user slides the credit card for buying a product, the secure application module of the identification module 108 performs the authentication process for make sure whether the credit card is usable and rightful. According to an authentication result of the identification module 108, the microcontroller 110 exchanges data with the backend device 112 through the communication interface 100, so as to finish the trading. Preferably, a format of the card slot 106 conforms to a smart card slot.

When performing the contactless card reading function, the antenna 102 induces a contactless card. Then, according to a protocol of radio frequency identification, the microcontroller 110 processes data stored in the contactless card induced by the antenna 102 with the protocol processor 104. For example, the contactless card can be an electronic wallet. A user can buy points into the electronic wallet like depositing cash. When buying a product or service with the electronic wallet, the user can take the contactless card into a range of electromagnetic induction of the antenna 102 to finish the trading. Preferably, the microcontroller 110 can perform algorithms of international accreditation, such as DES, 3DES, etc., so as to encrypt data between the antenna 108 and the contactless card. Moreover, the present invention can identify the contactless card induced by the antenna 102 with the identification module 108, so as to determine whether the contactless card is authorized or not.

In the present invention, the communication interface 100 can exchange data with the backend device through a wired or wireless channel, which conforms to protocols of compact flash (CF), security digital (SD), personal computer memory card international association (PCMICA) interfaces. The backend device can be a computer system, PDA, POS (point of sales) machine, or other mobile devices capable of performing financial applications, and preferably, connect to a financial institution through a wireless channel.

Therefore, the card reading device 10 performs both the contact and contacless card reading functions, so that the user can take the contactless card into the range of the antenna 102 to finish contactless financial service through RFID technology. Since an RFID system transmits digital data through a radio frequency channel, such that there is no specified direction to be obeyed as the RFID reader reads the contactless card, and the contactless card can be read even if it is stored in one's pocket or wallet. Therefore, installing the card reading device 10 on a mobile device with a wireless network, a store can provide financial service in large-scale amusement parks or scenic spots, which increases convenience and saves trading time.

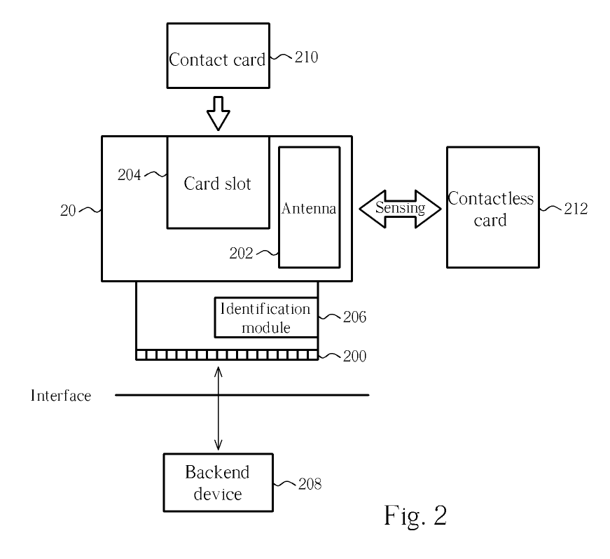

As to operations of the present invention, please refer to FIG. 2, which illustrates a schematic diagram of operations of a card reading device 20 in accordance with the present invention. Functions and elements of the card reading device 20 are same as that of the card reading device 10 shown in FIG. 1. For clarity, FIG. 2 shows a communication interface 200, an antenna 202, a card slot 204, and an identification module 206 of the card reading device 20. The communication interface 200 connects to a backend device 208 through a mobile interface, such as CF, SD, and PCMCIA interfaces. The antenna 202 can induce a contactless card 212 according to the RFID technology. The card slot 204 can embed a contact card 210.

In FIG. 2, when the contact card 210 is inserted into the card slot 204, the identification module 206 recognizes whether the contact card 210 is authorized. If so, the card reading device 20 can exchange data with the backend device 208. In addition, when the contactless card 212 is inside an inducing range of the antenna 202, the card reading device 20 can process data stored in the contactless card 212 according to the RFID protocol. Certainly, a financial institution can integrate the contact card 210 and the contactless card 212 into a card for convenience.

Therefore, the present invention discloses a card reading device having both the contact and contactless card reading functions, so as to perform mobile financial service, increase convenience, and save trading time.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A card reading device having both contact and contactless card reading functions, comprising:
a communication interface for transmitting and receiving signals;
an antenna for electromagnetically inducing a contactless card;
a protocol processor for exchanging data with the contactless card through the antenna according to a predetermined communication protocol;
a card slot for embedding a contact card;
an identification module for identifying the contact card; and
a microcontroller for processing data stored in the contactless card induced by the antenna through the protocol processor, and exchanging data with a backend device through the communication interface when a result of the identification module represents that the contact card conforms to a predetermined authentication.

2. The card reading device of claim 1, wherein the communication interface is utilized for transmitting and receiving signals through a wireless channel.

3. The card reading device of claim 1, wherein the communication interface is utilized for transmitting and receiving signals through a wired channel.

4. The card reading device of claim 3, wherein the communication interface conforms to a protocol of a memory card interface.

5. The card reading device of claim 4, wherein the memory card interface is a compact flash card interface.

6. The card reading device of claim 4, wherein the memory card interface is a security digital card interface.

7. The card reading device of claim 3, wherein the communication interface conforms to a protocol of a personal computer memory card international association (PCMCIA) interface.

8. The card reading device of claim 1, wherein the predetermined communication protocol conforms to a protocol of radio frequency identification.

9. The card reading device of claim 1, wherein the backend device is capable of performing financial applications.

10. The card reading device of claim 1, wherein the backend device is a computer system.

11. The card reading device of claim 1, wherein the backend device is a personal digital assistant.

12. The card reading device of claim 1, wherein the backend device is a point of sales system.

13. The card reading device of claim 1, wherein the contact card is a financial card issued by a financial organization.

14. The card reading device of claim 1, wherein the microcontroller is further utilized for encrypting data transferred between the antenna and the contactless card according to an encryption rule.

15. The card reading device of claim 1, wherein the identification module comprises a secure application module.

16. The card reading device of claim 1, wherein the identification module is further utilized for identifying the contactless card.

17. The card reading device of claim 16, wherein the microcontroller is further utilized for exchanging data with a backend device through the communication interface when a result of the identification module represents that the contactless card conforms to a predetermined authentication data.

18. The card reading device of claim 1, wherein the contact card and the contactless card are integrated in a card.
